(19) United States
(12) Patent Application Publication
(10) Pub. No.: US 2017/0113615 A1
(43) Pub. Date: Apr. 27, 2017

(54) SYSTEM FOR DETECTING A VEHICLE ENVIRONMENT OF A MOTOR VEHICLE

(71) Applicant: Conti Temic microelectronic GmbH, Nurnberg (DE)

(72) Inventor: Günter Anton Fendt, Schrobenhausen (DE)

(73) Assignee: Conti Temic microelectronic GmbH, Nürnberg (DE)

(21) Appl. No.: 15/400,463

(22) Filed: Jan. 6, 2017

Related U.S. Application Data
(63) Continuation of application No. PCT/DE2015/200401, filed on Jul. 7, 2015.

(30) Foreign Application Priority Data
Jul. 9, 2014 (DE) 10 2014 213 279.7

(51) Int. Cl. B60R 1/00; B60K 35/00; B60R 1/074

(52) U.S. Cl. CPC B60R 1/00; B60R 1/074; B60K 35/00; B60R 2300/8046; B60R 2300/101; B60R 2001/1253

(57) ABSTRACT

A system for detecting a vehicle environment of a motor vehicle includes an exterior mirror which can be pivoted between a normal position and a folded position with respect to the vehicle. The system also includes a camera arranged on the exterior mirror for detecting the vehicle environment such that in the normal position a field of view of the camera is directed downwards in the direction of a road surface and in the folded position the field of view of the camera is directed backwards counter to the direction of travel for detecting a rear vehicle environment.

### CROSS REFERENCE TO RELATED APPLICATION

This application claims the benefit of International application No. PCT/DE2015/200401, filed Jul. 7, 2015, which claims priority to German patent application No. 10 2014 213 279.7, each of which are hereby incorporated by reference.

### TECHNICAL FIELD

The technical field relates generally to a system for detecting a vehicle environment of a motor vehicle, and in particular to a system for detecting a rear vehicle environment if the exterior mirrors of the motor vehicle are in a folded position with respect to the vehicle.

### BACKGROUND

For monitoring a rear vehicle environment of a motor vehicle by a driver of the motor vehicle, apart from an internal mirror of the vehicle, usually left and right exterior mirrors are also used which, by way of example, are laterally hinge-mounted on the doors or the respective A-pillar.

Since the exterior mirrors are usually arranged outside of the vehicle, these take up additional space in the width of the motor vehicle, thereby causing additional wind resistance at high vehicle speeds, especially as the exterior mirrors at high speeds act as wind capture surface areas. Therefore, at high vehicle speeds an exterior mirror of a motor vehicle can lead to an increase in the drag coefficient (Cd) of 5% or more which in turn leads to increased gas consumption.

Printed publication DE 3839322 A1 discloses an exterior mirror for a motor vehicle, which is hinge-mounted on the vehicle by means of an actuating device so that it can pivot between a normal position and a folded position with respect to the vehicle, so that at high vehicle speeds the exterior mirror can be folded against the vehicle and, in this way, the increased gas consumption at high speeds due to the drag coefficient of the exterior mirror is reduced.

If the exterior mirrors of the motor vehicle are in a folded position with respect to the vehicle, however, they can no longer be used by the driver of the motor vehicle to monitor a rear vehicle environment of the motor vehicle. At high vehicle speeds in particular, a driver of a motor vehicle is, however, reliant upon information on the rear vehicle environment to recognize possible hazard situations early and respond accordingly.

As such, it is desirable to present a system for detecting a vehicle environment of a motor vehicle, with which a rear vehicle environment can be detected, even if the exterior mirrors of the vehicle are in a folded position with respect to the vehicle. In addition, other desirable features and characteristics will become apparent from the subsequent summary and detailed description, and the appended claims, taken in conjunction with the accompanying drawings and this background.

### BRIEF SUMMARY

In one exemplary embodiment, a system for detecting a vehicle environment of a motor vehicle includes at least one exterior mirror pivotable between a normal position and a folded position with respect to the vehicle. The system also includes a camera arranged on the at least one exterior mirror for detecting the vehicle environment. The camera is arranged on the at least one exterior mirror such that in the normal position a field of view of the camera is directed downwards in the direction of a road surface for detecting an immediate vehicle environment and in the folded position the field of view of the camera is directed backwards counter to the direction of travel for detecting a rear vehicle environment.

In another exemplary embodiment, a motor vehicle with a system for detecting a vehicle environment includes at least one exterior mirror pivotable between a normal position and a folded position with respect to the vehicle. The vehicle also includes a camera arranged on the at least one exterior mirror for detecting the vehicle environment. The camera is arranged on the at least one exterior mirror such that in the normal position a field of view of the camera is directed downwards in the direction of a road surface for detecting an immediate vehicle environment and in the folded position the field of view of the camera is directed backwards counter to the direction of travel for detecting a rear vehicle environment.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a schematic block diagram of a system for detecting a vehicle environment of a motor vehicle according to one exemplary embodiment;

FIG. 2 is a schematic view of the motor vehicle with exterior mirrors in a normal position according to one exemplary embodiment; and

FIG. 3 is a schematic view of the motor vehicle with exterior mirrors in a folded position according to one exemplary embodiment.

### DETAILED DESCRIPTION

According to an exemplary embodiment, a system for detecting a vehicle environment of a motor vehicle includes at least one pivotable exterior mirror which can be pivoted between a normal position and a folded position with respect to the vehicle, and a camera arranged on the at least one pivotable exterior mirror for detecting the vehicle environment. The camera is arranged on the at least one pivotable exterior mirror such that in the normal position of the at least one exterior mirror a field of view of the camera is directed downwards in the direction of a road surface for detecting an immediate vehicle environment, and in the folded position with respect to the vehicle of the at least one exterior mirror the field of view of the camera is directed backwards counter to the direction of travel for detecting a rear vehicle environment.

The basic concept is thus to arrange a camera on an exterior mirror of a motor vehicle such that this can be used multifunctionally, e.g., for detecting an immediate vehicle environment if the exterior mirror is in its normal position, and for detecting a rear vehicle environment if the exterior mirror has been pivoted into a folded position with respect to the vehicle.

The system has the advantage that it allows a rear vehicle environment to be detected even if the exterior mirror is in a folded position with respect to the vehicle. Thus, by means of the camera arranged on the exterior mirror, which serves as a substitute for the function of the exterior mirror if this has been pivoted into a folded position with respect to the vehicle, by way of example to reduce the gas consumption at high speeds, the driver of the motor vehicle can in this situation also be provided with information on a rear vehicle environment, so that they may respond in good time to a possible hazard situation, by way of example to an impending collision with another motor vehicle approaching from behind, and perform corresponding driving maneuvers. Cameras arranged on an exterior mirror of a motor vehicle for monitoring an immediate vehicle environment, by way of example as part of a 360° surround vision system for the motor vehicle, are also known, so that the system can be implemented by components that are known and commonly used for normal motor vehicles, without complicated and costly modifications being necessary.

The system may further include an actuator for automatically pivoting the exterior mirror from the normal position to the folded position with respect to the vehicle in response to the presence of a pivot condition. The pivot condition may be the exceeding of a threshold value for a vehicle speed or the undershooting of a threshold value for a lane width.

The automatic pivoting of the exterior mirror from the normal position to the folded position with respect to the vehicle by the actuator has the advantage that the driver of the motor vehicle, in particular at high vehicle speeds, is not unnecessarily distracted from driving and can therefore concentrate more fully on the traffic situation in front. The actuator for automatically pivoting exterior mirrors from a normal position to a folded position with respect to the vehicle are also known for normal motor vehicles, by way of example, for transferring the motor vehicle in a parked position to a protected position, so that for normal motor vehicles known components and functions can be used, without complicated and costly modifications being necessary. Here the threshold value for the vehicle speed can, by way of example, be a specified high speed of approximately 100 km/h. The threshold value for the lane width can further, by way of example, be undershot if the motor vehicle with the folded out exterior mirrors, e.g. with the exterior mirrors in the normal position, would take up the entire lane width of a highway currently being traveled. Here the actuator can further be designed to automatically pivot the exterior mirror back into the normal position, if the pivot condition is no longer present. The actuator can also be designed for manual pivoting of the exterior mirror from the normal position to the folded position with respect to the vehicle as well, however.

In addition, the system may include a display unit for visualization of the vehicle environment detected by the camera. In particular, the image data detected by the camera can be forwarded to the display unit arranged within the vehicle and displayed on the display unit with the driver of the vehicle thus being given the possibility of looking at, e.g., monitoring, a rear vehicle environment, even if the exterior mirror is in a folded position with respect to the vehicle, e.g., cannot be used for monitoring the rear vehicle environment. By looking at the rear vehicle environment via the display unit the driver of the vehicle now has the possibility, even with the exterior mirrors folded in, to recognize a possible hazard situation early and to respond to the situation, by way of example an impending collision with another motor vehicle approaching from behind, and perform corresponding driving maneuvers.

According to an exemplary embodiment, the system may also include a controller for adapting detection properties of the camera based on a current position of the exterior mirror. By adapting the detection properties of the camera, the differing demands of the individual driving situations, by way of example in terms of the reaction distance, and resulting requirements for the detection properties of the camera can be taken into consideration. Thus, by way of example, at high vehicle speeds, in particular at speeds that are higher than the threshold value for the vehicle speed beyond which the exterior mirror is pivoted to the folded position with respect to the vehicle, significantly longer reaction distances result than at low vehicle speeds, so that it must be ensured that the detection properties of the camera are selected in such a way that possible hazard situations, by way of example motor vehicles approaching from behind, can be detected as early as possible.

The detection properties may, by way of example, involve a detection range of the camera. Thus, the camera may have a zoom function for setting the detection range of the camera and the controller be configured, in response to the pivoting of the exterior mirror from the normal position to the folded position with respect to the vehicle, to change the detection range of the camera from a near field to a far field. Here the far field can, compared to the near field, in particular detect with greater coverage but with a smaller angle area, to meet the corresponding requirements, e.g., being able to detect possible hazard situations correspondingly early. Here the controller may be further configured to change the detection range of the camera back to the near field, if the exterior mirror is pivoted back out of the folded position with respect to the vehicle into the normal position. The detection properties may also involve further features of the camera, however, by way of example optical characteristics of the camera.

In addition, the system may also include a current driving situation detector for detecting a current driving situation. The controller may be configured to adapt the far field to the current driving situation. Thus, for setting the detection properties of the camera in the far field a further function, in particular a speed-dependent function, may be used to adapt the detection properties of the camera more specifically to the current requirements. Thus, by way of example, it is desirable at high speeds of the motor vehicle due to the longer reaction distances, to ensure a correspondingly greater detection range, whereas at low speeds of the vehicle the focus should be more on the near field area.

Here the current driving situation detector may include a speed sensor for detecting a current vehicle speed and/or local identification system to determine a place currently being passed through and/or a highway type detector for determining a highway type of a highway currently being traveled. Because the current vehicle speed is used to set the detection properties, by way of example at high vehicle speeds, a greater detection range can be implemented than at low vehicle speeds, to be able to detect a possible hazard situation as early as possible. By considering a location currently being passed through a current vehicle position can be fed into the setting of the detection properties of the camera, by way of example consideration given to whether the motor vehicle is inside or outside a built-up area. Thus, when adapting the far field, by way of example, consideration can be given to the fact that speed limits generally apply in built-up areas. By means of the determined highway type, by way of example also, consideration can be given to whether the motor vehicle is currently moving along an expressway, a federal highway or a country road, so that corresponding account can be taken of the resulting differences, by way of example concerning the permitted maximum speeds, when adapting the far field.

In a further exemplary embodiment, a motor vehicle is also indicated, having a system as described above. Such a motor vehicle has the advantage that a rear vehicle environment can be detected by means of the system even if the exterior mirrors of the motor vehicle are in a folded position with respect to the vehicle. Thus, by the camera arranged on the exterior mirror, which serves as a substitute for the function of the exterior mirror if this has been pivoted into a folded position with respect to the vehicle, to reduce the gas consumption at high speeds, the driver of the motor vehicle, can in this situation also be provided with information on a rear vehicle environment, so that they may respond in good time to a possible hazard situation, by way of example, to an impending collision with another motor vehicle approaching from behind, and perform corresponding driving maneuvers. Cameras arranged on the exterior mirror of the motor vehicle for monitoring an immediate vehicle environment, by way of example, as part of a 360° surround vision system for the motor vehicle, are also known, so that the system can be implemented by components that are known and commonly used for normal motor vehicles, without complicated and costly modifications being necessary.

The display unit may be a screen of an infotainment system of a motor vehicle or a head-up display. Normal motor vehicles are increasingly being equipped with infotainment systems, comprising a plurality of, in particular wireless, devices and which serve to provide entertainment programs and/or information programs for the users of the vehicle. By way of example, information programs can be provided, which assist a driver of the motor vehicle in various driving situations with downloadable information or warnings that can be given automatically and/or automatically perform actions relating to the driving behavior of the vehicle. Head-up displays are used in normal motor vehicles to project information onto windows of the motor vehicle, by way of example, a windshield of the motor vehicle, which is identifiable there by the driver of the motor vehicle, without having to divert their attention from the highway.

The display unit may be arranged within the vehicle so that for the driver of the motor vehicle the vehicle environment is perceptible behind a side window of the vehicle as a virtual image, if the exterior mirror is in the folded position with respect to the vehicle. Thus, a driver of a motor vehicle looks as normal in the exterior mirror and thus through the exterior mirror of the vehicle, to see the rear vehicle environment. It can therefore be ensured that the driver of the motor vehicle is provided with the detected information, even if the exterior mirror has been folded in, where they would intuitively expect this to be. The projection onto the side window can be implemented here, by way of example, by arranging a realistic display unit or a projector in the vicinity of the instrument panel of the motor vehicle such that the driver can perceive the image by a reflection in the side window.

Thus the system of an exemplary embodiment includes a multifunctional camera arranged on a pivotable exterior mirror of a motor vehicle, arranged on the exterior mirror such that in the normal position of the exterior mirror a field of view of the camera is directed downwards in the direction of a road surface, for detecting an immediate vehicle environment, and in the folded position with respect to the vehicle of the exterior mirror the field of view of the camera is directed backwards counter to the direction of travel for detecting a rear vehicle environment.

By adapting the detection properties of the camera, differing demands of the individual driving situations, by way of example, in terms of the reaction distance, and resulting requirements for the detection properties of the camera can also be taken into consideration. As one example, the detection range of the camera can be varied between a near field for detection of the immediate vehicle environment and a far field for detecting the rear highway environment.

For adapting the detection properties of the camera in the far field, a further function, in particular a speed-dependent function can be used to adapt the detection properties of the camera more specifically to the current requirements.

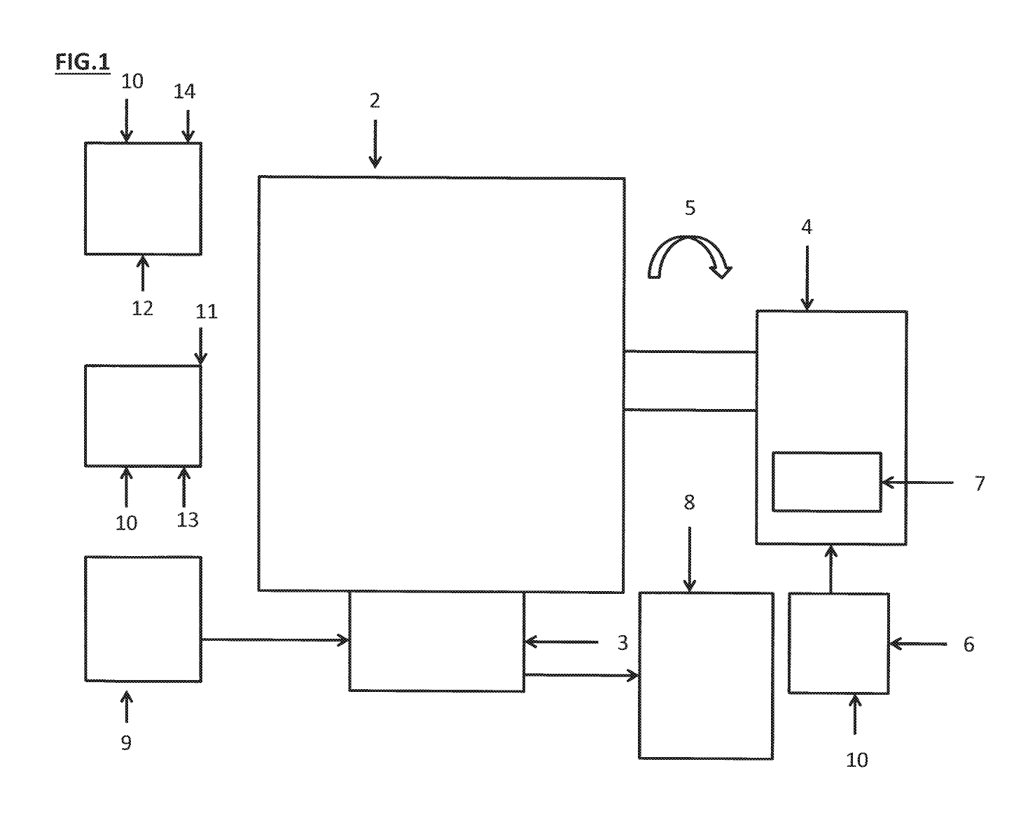

The invention is now explained in more detail using the attached figures. As shown in FIG. 1, the system 1 includes an exterior mirror 2, which can be pivoted between a normal position and a folded position with respect to the vehicle and a camera 3 arranged on the pivotable exterior mirror 2 for detecting the vehicle environment.

To ensure low gas consumption at high vehicle speeds, the exterior mirror 2 according to FIG. 1 is configured here such that this exterior mirror 2 can be pivoted into a folded position with respect to the vehicle, so that the motor vehicle at high speeds has the lowest possible drag coefficient, to reduce the gas consumption. According to the embodiments of FIG. 1, to this end the system 1 comprises an actuator 4, coupled by guide members to the exterior mirror 2 and configured to upwardly rotate the exterior mirror 2 from a normal position, in which the exterior mirror 2 is arranged at an angle of approximately 70-85° to the outside of the vehicle, by means of a combined rotational and upward movement of the guide members and at the same time place them against the vehicle, to pivot the exterior mirror 2 into a folded position with respect to the vehicle, e.g., a high-speed position. Here the combined rotational movement is indicated by the arrow with reference number 5. Here the actuator 4 is further configured, by reversing this rotational movement, to transfer the exterior mirror 2 from the folded position with respect to the vehicle back to the normal position.

If the exterior mirror 2 is now in a folded position with respect to the vehicle, however, e.g., in its high-speed position, then this can no longer be used for its true function, e.g., for monitoring a rear vehicle environment of the vehicle by the driver of the motor vehicle.

According to the embodiment of FIG. 1, the camera 3 is arranged on the exterior mirror 2 such that it can be used multifunctionally, e.g., in the normal position of the exterior mirror 2 a field of view of the camera 3 is directed downwards in the direction of a road surface, for detecting an immediate vehicle environment, and in the folded position with respect to the vehicle of the exterior mirror 2 the field of view of the camera 3 is directed backwards counter to the direction of travel for detecting a rear vehicle environment.

The camera 3 according to FIG. 1 is part of a 360° surround vision system for normal motor vehicles, so that the system can be implemented by components that are known and commonly used for normal motor vehicles, without complicated and costly modifications being necessary.

Such a system 1 has the advantage that it allows a rear vehicle environment to be detected even if the exterior mirror 2 is in a folded position with respect to the vehicle. Thus, by means of the camera arranged on the exterior mirror 2, which serves as a substitute for the function of the exterior mirror 2 if this has been pivoted into a folded position with respect to the vehicle, by way of example to reduce the gas consumption at high speeds, the driver of the motor vehicle can in this situation also be provided with information on a rear vehicle environment, so that they may respond in good time to a possible hazard situation, by way of example, to an impending collision with another motor vehicle approaching from behind, and perform corresponding driving maneuvers.

According to the embodiments of FIG. 1, the actuator is configured for automatically pivoting the exterior mirror 2 from the normal position to the folded position with respect to the vehicle in response to the presence of a pivot condition.

According to the embodiments of FIG. 1, the pivot condition here is the exceeding of a threshold value for the vehicle speed. As shown in FIG. 1, to this end the actuator 4 is coupled to a speed sensor 6 for measuring a current vehicle speed. The actuator 4 also includes a comparator 7, for comparing the measured current vehicle speed with a stored threshold value for the vehicle speed. Here the actuator 4 is configured to pivot the exterior mirror automatically from the normal position to the folded position with respect to the vehicle, if in the comparator 7 it is detected that the current vehicle speed is greater than the stored threshold value for the vehicle speed. Here the threshold value for the vehicle speed can, by way of example, be a value of 100 km/h. Here the actuator 4 according to FIG. 1 is further configured to also automatically pivot the exterior mirror 2 from the folded position with respect to the vehicle back to the normal position, if the pivot condition is no longer present. In addition, however, the actuator 4 may also be configured to automatically pivot the exterior mirror in response to further pivot conditions, by way of example, if a width of a highway currently being traveled undershoots a stored threshold for the lane width. The actuator 4 may also be configured, however, for manual pivoting of the exterior mirror from the normal position to the folded position with respect to the vehicle.

FIG. 1 also shows a display unit 8 for visualization of the vehicle environment detected by the camera 3. Here the image data detected by the camera 3 may be forwarded to a display unit 8 and displayed on this with a driver of the vehicle by the display unit 8, thus being given the possibility of looking at, e.g., monitoring, a rear vehicle environment, even if the exterior mirror 2 is in its folded position with respect to the vehicle and thus cannot be used for monitoring the rear vehicle environment.

A controller 9 may also be identified for adapting detection properties of the camera 3 based on a current position of the exterior mirror 2.

According to the embodiments of FIG. 1, here the detection properties of the camera 3 adapted by the controller 9 involve a detection range of the camera 3. Here the camera 3 has a zoom function for setting a detection range of the camera 3 and the controller 9 is configured, in response to the pivoting of the exterior mirror 2 from the normal position to the folded position with respect to the vehicle, to change the detection range of the camera from a near field to a far field. Here the far field detects, compared to the near field, in particular with greater coverage, but with a smaller angle area, to meet the corresponding requirements.

Further means 10 can be identified for detecting a current driving situation. The controller 9 according to FIG. 1 is also configured here to adapt the far field to the current driving situation.

Here the current driving situation detector 10 shown involves a speed sensor 6 for detecting a current vehicle speed, the location identification system 11 to determine a place currently being passed through and high type detector 12 for determining a type of a highway currently being traveled. In this way, for setting the detection properties of the camera 3 in the far field, a further speed-dependent function can be used to adapt the detection properties of the camera 3 more specifically to the current requirements. Thus, by way of example, it is desirable at high speeds of the motor vehicle to ensure a correspondingly greater detection range to detect a possible hazard situation as early as possible, whereas at low speeds of the vehicle the focus should be more on the near field area of the vehicle. By considering a location currently being passed through, a current vehicle position can be fed into the setting of the detection properties of the camera, by way of example consideration given to whether the motor vehicle is inside or outside a built-up area. Thus, when adapting the far field, by way of example consideration can be given to the fact that speed limits generally apply in built-up areas. By means of the determined highway type, by way of example also, consideration can be given to whether the motor vehicle is currently moving along an expressway, a federal highway or a country road, so that corresponding account can be taken of the resulting differences, by way of example concerning the permitted maximum speeds, when adapting the far field.

According to the embodiments of FIG. 1, the location identification system 10 involve a GPS (Global Positioning System) module 13. The location identification system, however, can also involve further modules for position determination such as for example a GLONASS (Global Navigation Satellite System) module and/or a compass module and/or a Galileo module and/or an IRNSS (Indian Regional Navigation Satellite System) module and/or an EGNOS (European Geostationary Navigation Overlay Service) module and/or a GAGAN (GPS Added Geo Augmented Navigation) module and/or a WAAS (Wide Area Augmentation System) module. Extended map materials can also be used to determine the current vehicle position, wherein the extended map data can involve data of a digital map and additional information relating to a POI (Point of Interest) information and/or Web information.

The highway type detector 12 may also involve a camera-based environment detection system 14. The detector 12 may also involve further environment sensors suitable for detecting a highway type of a highway currently being traveled.

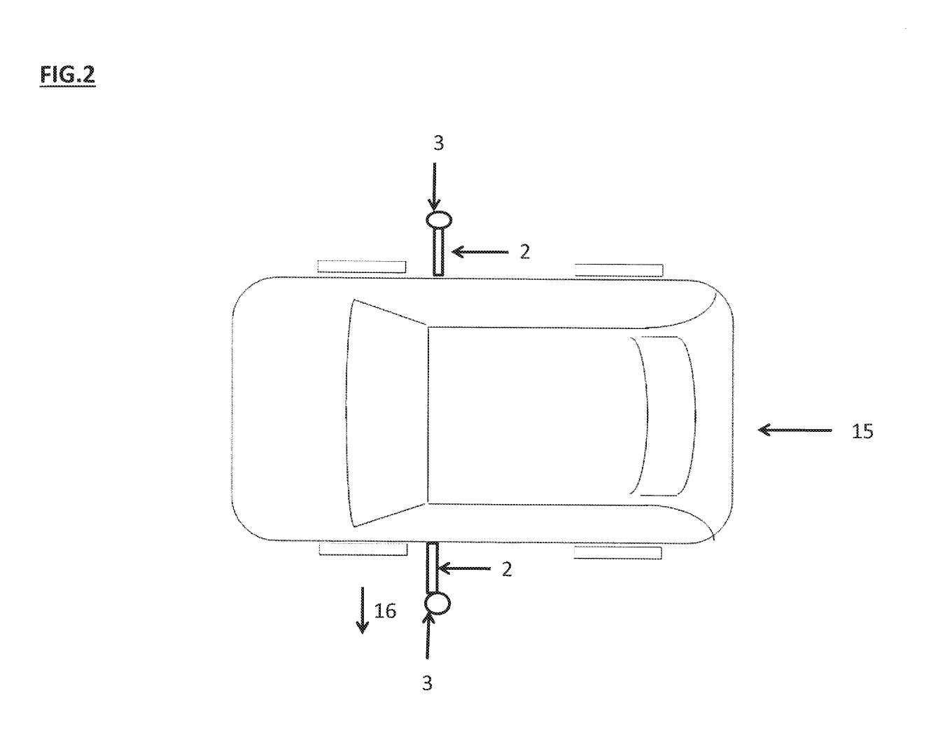

FIG. 2 is a schematic view of a motor vehicle 15 according to an exemplary embodiment. Components and parts with the same function or construction as in FIG. 1 are given the same reference numerals here and are not discussed further. Here the motor vehicle 15 has a system for detecting a vehicle environment as described above.

FIG. 2 shows the exterior mirrors 2 of the vehicle 15, each here in their normal position. In this position the cameras 3 arranged on the respective exterior mirrors 2, which are part of a 360° surround vision system for the motor vehicle, are directed downwards in the direction of a road surface for detecting an immediate vehicle environment. The field of view of the cameras is symbolized here by the arrow having reference numeral 16.

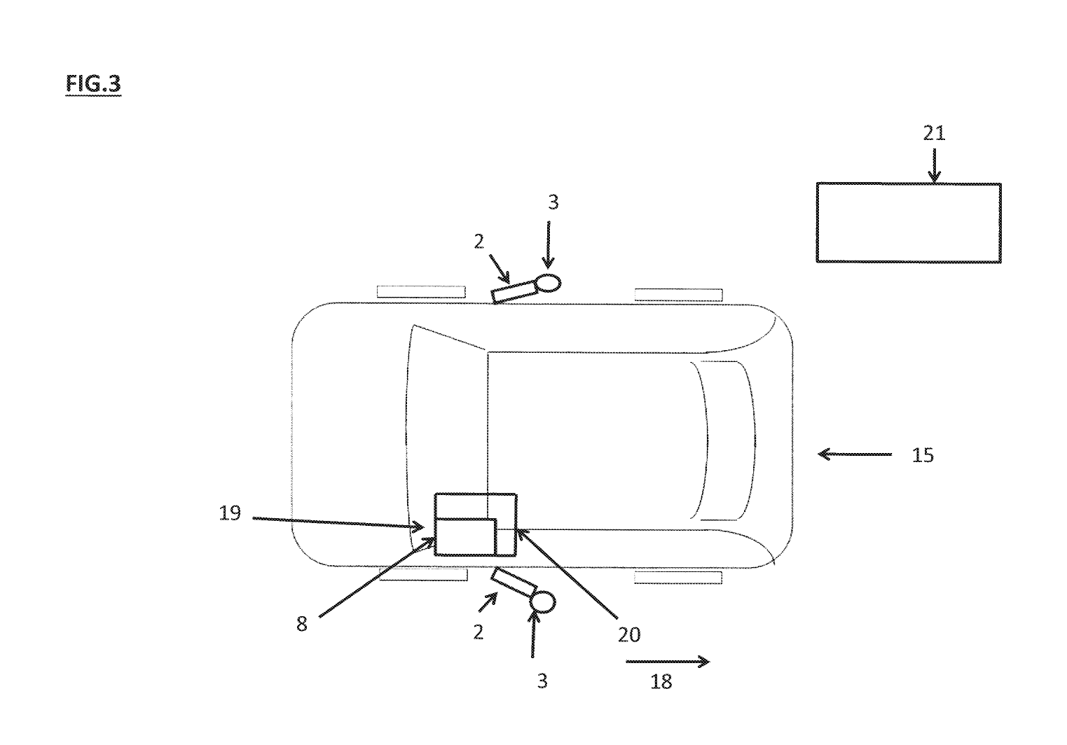

FIG. 3 is a schematic view of a motor vehicle 15 according to an exemplary embodiment. Components and parts with the same function or construction as in FIG. 1 or FIG. 2 are given the same reference numerals here and are not discussed further.

FIG. 3 shows the exterior mirrors 2 of the vehicle 15, each here in their folded position with respect to the vehicle. In this position of the exterior mirror 2 the motor vehicle 15, compared with the normal position of the exterior mirror, has a lower drag coefficient, so that a lower gas consumption at high vehicle speeds can be ensured.

In this position the cameras 3 arranged on the respective exterior mirrors 2, are directed backwards counter to the direction of travel, for detecting a rear vehicle environment. The field of view of the cameras 3 is shown here by the arrow having reference numeral 18.

Here the information detected by the cameras 3 is forwarded to the display unit 8 and visualized on this. According to the embodiments of FIG. 3, the display unit involved here is a head-up display 19. The display unit can also, by way of example, involve a screen of an infotainment system of the vehicle, however.

As shown in FIG. 3, the head-up display 19 is arranged here inside the motor vehicle 15, such that the detected vehicle environment is perceptible behind a side window 20 of the motor vehicle 15 as a virtual image. Thus, the driver of the vehicle 13 is provided with the detected information, even if the exterior mirror 2 has been folded in, where they would intuitively expect this to be.

FIG. 3 also shows a further motor vehicle 21 approaching from behind. Since by means of the cameras 3 arranged on the exterior mirrors 2, which serve as a substitute for the function of the exterior mirrors, if these have been pivoted into the folded position with respect to the vehicle 13, by way of example to reduce the gas consumption at high speeds, the driver of the vehicle 13 can be provided in this situation also with information on a rear vehicle environment, they can respond in good time to the situation, in particular an impending collision with the approaching other motor vehicle 21, and perform corresponding driving maneuvers.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A system for detecting a vehicle environment of a motor vehicle, comprising:
at least one exterior mirror pivotable between a normal position and a folded position with respect to the vehicle; and
a camera arranged on the at least one exterior mirror for detecting the vehicle environment;
wherein the camera is arranged on the at least one exterior mirror such that in the normal position a field of view of the camera is directed downwards in the direction of a road surface for detecting an immediate vehicle environment and in the folded position the field of view of the camera is directed backwards counter to the direction of travel for detecting a rear vehicle environment.

2. The system according to claim 1, further comprising an actuator for automatically pivoting the at least one exterior mirror from the normal position to the folded position in response to the presence of a pivot condition.

3. The system according to claim 2, wherein the pivot condition comprises exceeding a threshold value for a vehicle speed.

4. The system according to claim 2, wherein the pivot condition comprises undershooting a threshold value for a lane width.

5. The system according to claim 1, further comprising a display unit for visualizing the vehicle environment detected by the camera.

6. The system according to claim 1, further comprising a controller for adapting detection properties of the camera based on a current position of the at least one exterior mirror.

7. The system according to claim 6, wherein the camera comprises a zoom function for setting a detection range of the camera and wherein the controller is configured, in response to the pivoting of the at least one exterior mirror from the normal position to the folded position, to change the detection range of the camera from a near field to a far field.

8. The system according to claim 7, further comprising a current driving situation detector for detecting the current driving situation and wherein the controller is also configured to adapt the far field to the current driving situation.

9. The system according to claim 8, wherein the current driving situation detector comprises a speed sensor for detecting a current vehicle speed.

10. The system according to claim 8, wherein the current driving situation detector comprises location identification system to determine a place currently being passed through.

11. The system according to claim 8, wherein the current driving situation detector comprises a highway type detector for determining a type of highway currently being traveled.

12. A motor vehicle having a system for detecting a vehicle environment, said vehicle comprising:
at least one exterior mirror pivotable between a normal position and a folded position with respect to the vehicle; and
a camera arranged on the at least one exterior mirror for detecting the vehicle environment;
wherein the camera is arranged on the at least one exterior mirror such that in the normal position a field of view of the camera is directed downwards in the direction of a road surface for detecting an immediate vehicle environment and in the folded position the field of view of the camera is directed backwards counter to the direction of travel for detecting a rear vehicle environment.

13. The motor vehicle according to claim 12, further comprising a display unit, the display unit comprising a screen of an infotainment system of the motor vehicle or a head-up display.

14. The motor vehicle according to claim 13, wherein the display unit is arranged within the motor vehicle such that for a driver of the motor vehicle the detected vehicle environment is perceptible behind a side window of the motor vehicle as a virtual image, if the at least one exterior mirror is in the folded position with respect to the vehicle.
